(19) United States
(12) Patent Application Publication
(10) Pub. No.: US 2026/0025073 A1
(43) Pub. Date: Jan. 22, 2026

(54) METHOD FOR CONTROLLING BUCK-BOOST CIRCUIT, POWER CONVERSION DEVICE, ENERGY STORAGE DEVICE, AND STORAGE MEDIUM

(71) Applicant: ECOFLOW INC., Shenzhen (CN)

(72) Inventors: Wei QIN, Shenzhen (CN); Dong WU, Shenzhen (CN); Xi CHEN, Shenzhen (CN); Lei WANG, Shenzhen (CN)

(21) Appl. No.: 19/342,099

(22) Filed: Sep. 26, 2025

Related U.S. Application Data
(63) Continuation of application No. PCT/CN2024/083148, filed on Mar. 22, 2024.

(30) Foreign Application Priority Data
Mar. 31, 2023 (CN) 202310365202.5

(51) Int. Cl. H02M 3/158; H02M 1/08; H02M 3/07

(52) U.S. Cl. CPC H02M 3/1582; H02M 1/08; H02M 3/07

(57) ABSTRACT

A method for controlling a buck-boost circuit includes: obtaining an input voltage and an output voltage; controlling the buck-boost circuit to enter a buck-boost mode when an absolute value of a voltage difference between the input voltage and the output voltage is less than a preset voltage threshold; and executing within each control cycle: in a first stage, controlling both first and second low-side switching transistors to be conductive and controlling both first and second high-side switching transistors to be non-conductive; in a second stage, controlling both the first and second high-side switching transistors to be conductive and controlling both first and second low-side switching transistors to be non-conductive; and in a third stage, controlling both the first and second high-side switching transistors to be conductive and controlling both the first and second low-side switching transistors to be non-conductive.

### CROSS-REFERENCE TO RELATED APPLICATIONS

This application is a continuation application of PCT patent application No. PCT/CN2024/083148, filed on Mar. 22, 2024, which claims priority to Chinese Patent Application No. 202310365202.5, filed on Mar. 31, 2023, all of which is incorporated by reference in their entirety.

### TECHNICAL FIELD

The present application relates to the field of control technologies, and in particular, to a method for a buck-boost circuit, a power conversion device, an energy storage device, and a storage medium.

### BACKGROUND

Statements here only provide background information related to the present application and do not necessarily constitute an exemplary technology.

In some power conversion systems, to improve applicability of a power converter, the power converter usually needs to be capable of executing both a boost operation and a buck operation. Therefore, a buck-boost circuit is usually set in a power conversion system to implement buck-boost conversion. In a related design, an independent driving power supply or a bootstrap circuit is usually used to drive a switching transistor in the buck-boost circuit. When the independent driving power supply is used for driving, there are many components, a design is complex, and overall circuit costs are high. When the bootstrap circuit is used as a driver circuit of the buck-boost circuit, overall circuit costs can be effectively reduced. However, in a related control mode of the buck-boost circuit, in both a Buck mode and a Boost mode, an high-side switching transistor of a group of switching transistors is in a normally-on state and a low-side switching transistor is in a normally-off state, resulting that the high-side switching transistor of the group of switching transistors cannot be driven by using a conventional bootstrap circuit. Therefore, a method for controlling a buck-boost circuit is urgently needed, which can charge a bootstrap capacitor while implementing topological control and waveform generation.

### SUMMARY

According to embodiments of the present application, a method for controlling a buck-boost circuit, a power conversion device, an energy storage device, and a storage medium are provided.

An embodiment of the present application provides a method for controlling a buck-boost circuit. The buck-boost circuit includes a first bridge arm, a second bridge arm, an inductor, a first bootstrap circuit, and a second bootstrap circuit. The first bridge arm includes a first high-side switching transistor and a first low-side switching transistor that are connected between a positive direct current input end and a negative direct current input end. The second bridge arm includes a second high-side switching transistor and a second low-side switching transistor that are connected between a positive direct current output end and a negative direct current output end. The inductor is connected between a midpoint of the first bridge arm and a midpoint of the second bridge arm. The first bootstrap circuit is configured to perform bootstrap driving on the first high-side switching transistor. The second bootstrap circuit is configured to perform bootstrap driving on the second high-side switching transistor. The control method includes: obtaining an input voltage between a positive direct current input end and a negative direct current input end and obtaining an output voltage between a positive direct current output end and a negative direct current output end; controlling the buck-boost circuit to enter a buck-boost mode when an absolute value of a voltage difference between the input voltage and the output voltage is less than a preset voltage threshold; and when the buck-boost circuit operates in the buck-boost mode, executing within each control cycle: in a first stage, controlling both the first low-side switching transistor and the second low-side switching transistor to be conductive and controlling both the first high-side switching transistor and the second high-side switching transistor to be non-conductive, to simultaneously separately charge the first bootstrap circuit and the second bootstrap circuit; in a second stage, controlling both the first high-side switching transistor and the second low-side switching transistor to be conductive and controlling both the first low-side switching transistor and the second high-side switching transistor to be non-conductive; and in a third stage, controlling both the first high-side switching transistor and the second high-side switching transistor to be conductive and controlling both the first low-side switching transistor and the second low-side switching transistor to be non-conductive.

An embodiment of the present application provides a power conversion device, including a buck-boost circuit and a controller. The controller is configured to execute the method for controlling a buck-boost circuit according to any one of the foregoing items.

An embodiment of the present application further provides an energy storage device, including a battery module, a direct current input interface, and a power conversion device described above. The battery module is connected to a direct current output end of a buck-boost circuit. The direct current input interface is configured to be connected to a direct current power supply, and the direct current input interface is connected to a direct current input end of the buck-boost circuit.

An embodiment of the present application provides a computer-readable storage medium. The computer-readable storage medium storing a computer program. The computer program, when executed by a processor, enables the processor to implement the method for controlling a buck-boost circuit according to any one of the foregoing items.

Details of one or more embodiments of the present application are provided in the following accompanying drawings and descriptions. Other features, objectives, and advantages of the present application become apparent from the specification, the accompanying drawings, and the claims.

### BRIEF DESCRIPTION OF THE DRAWINGS

To describe technical solutions of the present application more clearly, the following briefly describes the accompanying drawings required for describing the embodiments. It should be understood that the following drawings illustrate only certain embodiments of the present application and should not be construed as limiting the scope of the present application. In the accompanying drawings, similar components use similar numbers.

FIG. 1 is a schematic diagram of an application environment of a power conversion device according to an embodiment of the present application.

FIG. 2 is a functional block diagram of a buck-boost circuit according to an embodiment of the present application.

FIG. 3A is a circuit diagram of an H-bridge in a buck-boost circuit according to an embodiment of the present application.

FIG. 3B is a circuit diagram of a first bootstrap circuit in a buck-boost circuit according to an embodiment of the present application.

FIG. 4A is a schematic flowchart of a first control method for a buck-boost circuit according to an embodiment of the present application.

FIG. 4B is a schematic flowchart of sub-steps of step S430 in FIG. 4A.

FIG. 5 is a schematic diagram of drive signals of switching transistors when a buck-boost circuit operates in a buck-boost mode according to an embodiment of the present application.

FIG. 6A to FIG. 6C are respectively equivalent circuit diagrams of an H-bridge in three stages when a buck-boost circuit operates in a buck-boost mode according to an embodiment of the present application.

FIG. 7A is a schematic flowchart of a second control method for a buck-boost circuit according to an embodiment of the present application.

FIG. 7B is a schematic flowchart of sub-steps of step S730 in FIG. 7A.

FIG. 8 is a schematic diagram of drive signals of switching transistors when a buck-boost circuit operates in a Buck mode according to an embodiment of the present application.

FIG. 9A to FIG. 9C are respectively equivalent circuit diagrams of an H-bridge in three stages when a buck-boost circuit operates in a Buck mode according to an embodiment of the present application.

FIG. 10A is a schematic flowchart of a third control method for a buck-boost circuit according to an embodiment of the present application.

FIG. 10B is a schematic flowchart of sub-steps of step S103 in FIG. 10A.

FIG. 11 is a schematic diagram of drive signals of switching transistors when a buck-boost circuit operates in a Boost mode according to an embodiment of the present application.

FIG. 12A to FIG. 12C are respectively equivalent circuit diagrams of an H-bridge in three stages when a buck-boost circuit operates in a Boost mode according to an embodiment of the present application.

FIG. 13 is a structural block diagram of a power conversion device according to an embodiment of the present application.

FIG. 14 is a structural block diagram of an energy storage device according to an embodiment of the present application.

FIG. 15 is a structural block diagram of a control apparatus according to an embodiment of the present application.

### DETAILED DESCRIPTION

Technical solutions in embodiments of the present application will be described in the following with reference to accompanying drawings in the embodiments of the present application. Apparently, the described embodiments are merely some rather than all of the embodiments of the present application.

Unless otherwise defined, all technical and scientific terms used herein have the same meanings as commonly understood by those skilled in the art belonging to the present application. Herein, terms used in this specification of the present application are merely intended to describe objectives of specific embodiments, but are not intended to limit the present application.

Some embodiments will be described below with reference to the accompanying drawings. The following embodiments and features in the embodiments may be combined with each other without conflict.

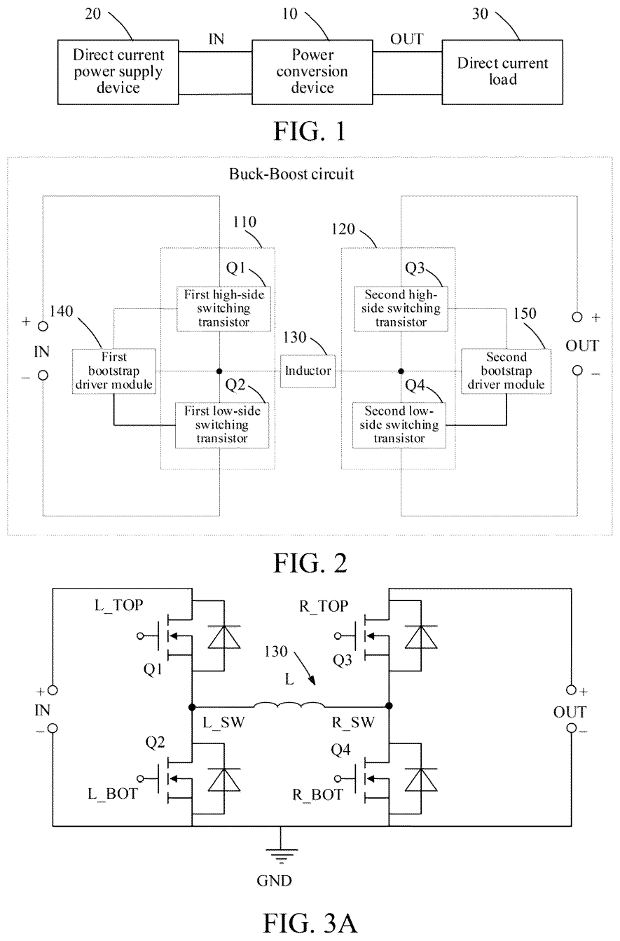

Referring to FIG. 1, in some power conversion systems, to improve applicability of a power conversion device, the power conversion device usually needs to be capable of executing both a boost operation and a buck operation.

For example, the power conversion system shown in FIG. 1 includes a power conversion device 10, a direct current power supply device 20, and a direct current load 30. The power conversion device 10 is a direct current conversion device. A direct current input end IN of the power conversion device 10 is electrically connected to the direct current power supply device 20, and a direct current output end OUT of the power conversion device 10 is electrically connected to the direct current load 30. The power conversion device 10 is configured to convert a direct current voltage output by the direct current power supply device 20 into another direct current voltage suitable for the direct current load 30. For example, the power conversion device 10 can step down a voltage output by the direct current power supply device 20 to a voltage suitable for the direct current load 30, or can step up a voltage output by the direct current power supply device 20 to a voltage suitable for the direct current load 30, thereby implementing a DC/DC voltage conversion function. In another embodiment, the power conversion device 10 may alternatively be an alternating current conversion device, configured to implement conversion between an alternating current and a direct current.

In this embodiment, a buck-boost circuit is disposed in the power conversion device 10 to implement buck-boost conversion from a direct current to a direct current. In a related design, an independent driving power supply or a bootstrap circuit is usually used to drive a switching transistor in the buck-boost circuit. When the independent driving power supply is used for driving, there are many components, a design is complex, and overall circuit costs are high. When the bootstrap circuit is used as a driver circuit of the buck-boost circuit, overall circuit costs can be effectively reduced. However, in a related control mode of the buck-boost circuit, in both a Buck mode and a Boost mode, a high-side switching transistor of a group of switching transistor is in a normally-on state and a low-side switching transistor is in a normally-off state, resulting that the high-side switching transistor of the group of switching transistor cannot be driven by using a conventional bootstrap circuit. Therefore, a method for controlling a buck-boost circuit is urgently needed, which can charge a bootstrap capacitor while implementing topological control and waveform generation.

Based on this, the present application provides a method for controlling a buck-boost circuit, which can charge a bootstrap capacitor while implementing control and waveform generation of the buck-boost circuit.

First, refer to FIG. 2 together, which is a partial circuit diagram of a buck-boost circuit applying a method for controlling a buck-boost circuit according to the present application.

It may be understood that a direct current input end IN of the buck-boost circuit is electrically connected to the direct current power supply device 20, and a direct current output end OUT of the buck-boost circuit is electrically connected to the direct current load 30.

The buck-boost circuit includes a first bridge arm 110, a second bridge arm 120, an inductor 130, a first bootstrap driver module 140, and a second bootstrap driver module 150. The first bridge arm 110 includes a first high-side switching transistor Q1 and a first low-side switching transistor Q2 that are connected between a positive direct current input end IN+ and a negative direct current input end IN−. The second bridge arm 120 includes a second high-side switching transistor Q3 and a second low-side switching transistor Q4 that are connected between a positive direct current output end OUT+ and a negative direct current output end OUT−. The inductor 130 is connected between a midpoint of the first bridge arm 110 and a midpoint of the second bridge arm 120, so that the first bridge arm 110 and the second bridge arm 120 form an H-bridge loop by using the inductor 130. That is, one end of the inductor 130 is electrically connected to the first high-side switching transistor Q1 and the first low-side switching transistor Q2, and the other end of the inductor 130 is electrically connected to the second high-side switching transistor Q3 and the second low-side switching transistor Q4.

The first bootstrap driver module 140 is electrically connected to a control end of the first high-side switching transistor Q1, a midpoint of the first bridge arm, and a control end of the first low-side switching transistor Q2. The first bootstrap driver module 140 is configured to drive the first high-side switching transistor Q1 and the first low-side switching transistor Q2 of the first bridge arm 110. The first bootstrap driver module 140 can be charged and store energy when the first low-side switching transistor Q2 is conductive, and discharges to the first high-side switching transistor Q1 to drive the first high-side switching transistor Q1 when the first low-side switching transistor Q2 is non-conductive, that is, the first bootstrap driver module 140 can implement bootstrap driving of the first high-side switching transistor Q1. The second bootstrap driver module 150 is electrically connected to a control end of the second high-side switching transistor Q3, a midpoint of the second bridge arm, and a control end of a second low-side switching transistor Q4. The second bootstrap driver module 150 is configured to drive the second high-side switching transistor Q3 and the second low-side switching transistor Q4 of the first bridge arm 120. The second bootstrap driver module 150 is charged and stores energy when the second low-side switching transistor Q4 is conductive, and discharges to the second high-side switching transistor Q3 to drive the second high-side switching transistor Q3 when the second low-side switching transistor Q4 is non-conductive, that is, the second bootstrap driver module 150 can implement bootstrap driving of the second high-side switching transistor Q3.

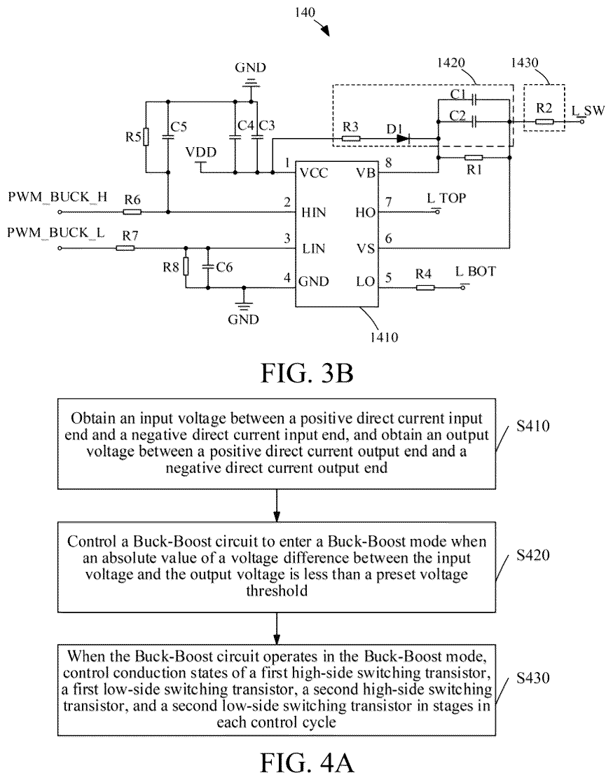

For example, continue to refer to FIG. 3A and FIG. 3B. FIG. 3A is a schematic diagram of a circuit connection of a first bridge arm 110, a second bridge arm 120, an inductor 130, a first bootstrap driver module 140, and a second bootstrap driver module 150 according to an embodiment. FIG. 3B is a schematic diagram of a first bootstrap driver module 140 according to an embodiment of the present application.

For example, the first high-side switching transistor Q1 and the first low-side switching transistor Q2 of the first bridge arm 110, and the second high-side switching transistor Q3 and the second low-side switching transistor Q4 of the second bridge arm 120 are all N-channel Metal-Oxide-Semiconductors (NMOSs). A first end (that is, a drain) of the first high-side switching transistor Q1 is electrically connected to a positive direct current input end IN+. A second end (that is, a source) of the first high-side switching transistor Q1 is electrically connected to a first end (that is, a drain) of the first low-side switching transistor Q2. A second end (that is, a source) of the first low-side switching transistor Q2 is connected to a negative direct current input end IN−. A control end (that is, a gate) L_TOP of the first high-side switching transistor Q1 and a control end (that is, a gate) L_BOT of the first low-side switching transistor Q2 are both electrically connected to the first bootstrap driver module 140. A first end of the second high-side switching transistor Q3 is electrically connected to the positive direct current output end OUT+. A second end of the second high-side switching transistor Q3 is electrically connected to a first end of a second low-side switching transistor Q4. A second end of the second low-side switching transistor Q4 is connected to a negative direct current output end OUT−. A control end R_TOP of the second high-side switching transistor Q3 and a control end R_BOT of the second low-side switching transistor Q4 are both electrically connected to the second bootstrap driver module 150. A first end L_SW of the inductor 130 is electrically connected between the second end of the first high-side switching transistor Q1 and the first end of the first low-side switching transistor Q2. A second end R_SW of the inductor 130 is electrically connected between the second end of the second high-side switching transistor Q3 and the first end of the second low-side switching transistor Q4.

Referring to FIG. 3A and FIG. 3B together, the first bootstrap driver module 140 is configured to drive the first bridge arm 110 according to a received control signal. The second bootstrap driver module 150 is configured to drive the second bridge arm 120 according to a received control signal. A specific circuit structure of the second bootstrap driver module 150 is the same as that of the first bootstrap driver module 140. Therefore, the present application is described by using the first bootstrap driver module 140 as an example. Specifically, the first bootstrap driver module 140 includes a driver chip 1410, a first bootstrap circuit 1420, and a first current limiting unit 1430. The first current limiting unit 1430 includes a resistor R2. The first bootstrap circuit 1420 includes a resistor R3, a diode D1, and a bootstrap capacitor C1. The driver chip 1410 includes a VCC pin, an HIN pin, an LIN pin, a GND pin, a VB pin, an HO pin, a VS pin, and an LO pin. Specifically, the VCC pin is electrically connected to a bias power supply VDD, and the HIN pin is electrically connected to a PWM_BUCK_H pin of a controller (not shown in the figure), to receive a PWM_BUCK_H control signal output by the controller. The PWM_BUCK_H control signal is a control signal used for controlling the first high-side switching transistor Q1. The LIN pin is electrically connected to a PWM_BUCK_L pin of the controller, to receive a PWM_BUCK_L control signal output by the controller. The PWM_BUCK_L control signal is a control signal used for controlling the first low-side switching transistor Q2. The GND pin is connected to the ground. The VB pin is electrically connected to an intersection L_SW of the inductor 130 and the first bridge arm 110 through a bootstrap capacitor C1 and a resistor R2. The VCC pin is further electrically connected to the VB pin through a resistor R3 and a diode D1. The HO pin is electrically connected to a control end L_TOP of the first high-side switching transistor Q1, and is configured to output a drive signal to drive the first high-side switching transistor Q1. The VS pin is electrically connected between the bootstrap capacitor C1 and the resistor R2. The LO pin is electrically connected to a control end L_BOT of the first low-side switching transistor Q2 through a resistor R4, so as to drive the first low-side switching transistor Q2.

A VCC pin is electrically connected to the basis power supply VDD to provide a bias voltage for the driver chip 1410. In some embodiments, the power supply VDD is configured to output a voltage of 12V The controller outputs a control signal to the driver chip 1410 by using the PWM_BUCK_H pin and the PWM_BUCK_L pin, so that the driver chip 1410 generates a corresponding drive signal according to the control signal, to control a conduction state of the first high-side switching transistor Q1 and the second high-side switching transistor Q2, and the first high-side switching transistor Q1 and the second high-side switching transistor Q2 are not simultaneously conductive. FIG. 3B is a commonly used bootstrap driver circuit in the art, and therefore, only some of the related circuits are described in detail.

Referring to FIG. 3A and FIG. 3B together, in this embodiment of the present application, an operating principle of the first bootstrap circuit 140 is approximately as follows:

When the PWM_BUCK_H pin of the controller outputs a low-level signal, and the PWM_BUCK_L pin outputs a high-level signal, a corresponding HIN pin receives the low-level signal, and the LIN pin receives the high-level signal. In this case, the HO pin is shorted to the VS pin, so that the HO pin outputs the same voltage as that of the VS pin. The LO pin outputs a high-level signal to the control end of the first low-side switching transistor Q2, so that the first low-side switching transistor Q2 is conductive. The VCC pin is electrically connected to the intersection L_SW of the first bridge arm 110 and the inductor 130 through the resistor R3, the diode D1, the bootstrap capacitor C1, and the resistor R2, and is connected to the ground through the intersection L_SW and the first low-side switching transistor Q2. In this way, the bias power supply VDD charges the bootstrap capacitors C1 and C2 through the diode D1.

When the PWM_BUCK_H pin of the controller outputs a high-level signal, and the PWM_BUCK_L pin outputs a low-level signal, a corresponding HIN pin receives the high-level signal, and the LIN pin receives the low-level signal. In this case, the HO pin is shorted to the VB pin, so that the HO pin outputs the same voltage as that of the VB pin. The LO pin outputs a low-level signal to the control end of the first low-side switching transistor Q2, so that the first low-side switching transistor Q2 is disconnected, and a charging loop of the bootstrap capacitor is disconnected. The diode D1 is unidirectionally conductive. In this way, a voltage on the bootstrap capacitor C1 is discharged to the VB pin and the HO pin, so that the control end of the first high-side switching transistor Q1 receives a high level, thereby driving the first high-side switching transistor Q1 to be conductive, and finally implementing bootstrap driving of the first high-side switching transistor Q1.

It may be understood that the present application does not limit a quantity of bootstrap capacitors. For example, in this embodiment of the present application, the quantity of bootstrap capacitors may be set according to a requirement. As shown in FIG. 2, the bootstrap capacitor C1 and the bootstrap capacitor C2 are connected in parallel between the diode D1 and the first current limiting unit 1440. In another embodiment, the quantity of bootstrap capacitors may alternatively be adjusted according to an application scenario.

In the present application, an example in which the buck-boost circuit is configured to control the direct current power supply device 20 to charge a battery module of the direct current load 30 is used for description. In this case, the direct current power supply device 20 may be a Photovoltaic (PV) board, a power grid, a charging pile, a charging base station, an energy storage device, or another device having a battery module, for example, an automobile having a battery module. The direct current power supply device 20 may alternatively be another direct current-direct current converter or an alternating current-direct current converter. The load 30 may alternatively be an energy storage device, an air conditioner, a refrigerator, a self-moving device, or the like. The self-moving device may be a lawn mower, a self-moving vehicle, a cleaning robot, or the like.

In this embodiment of the present application, a specific control process of the buck-boost circuit is described by using an example in which the direct current power supply device 20 is a PV module, and the direct current load 30 is a battery module BAT.

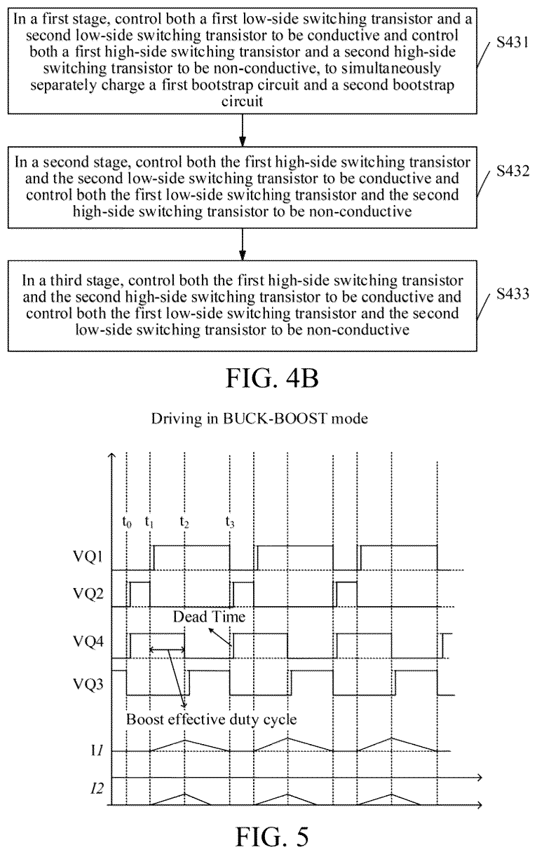

Refer to FIG. 4A, which is a schematic flowchart of a method for controlling a buck-boost circuit according to an embodiment of the present application. The control method may be executed by a controller, and the control method includes the following steps:

Step S410: Obtain an input voltage between a positive direct current input end and a negative direct current input end, and obtain an output voltage between a positive direct current output end and a negative direct current output end.

For example, an input voltage between a positive direct current input end IN+ and a negative direct current input end IN−, and a voltage between a positive direct current output end OUT+ and a negative direct current output end OUT− may be separately sampled by using sampling circuits, so as to obtain the input voltage and the output voltage. For another example, the input voltage between the positive direct current input end IN+ and the negative direct current input end IN−, and the output voltage between the positive direct current output end OUT+ and the negative direct current output end OUT− may alternatively be sampled by using an integrated chip having a voltage sampling function, for example, a front-end analog chip, so as to obtain the input voltage and the output voltage. A manner of obtaining the input voltage and the output voltage is not limited in the present application.

Step S420: Control a buck-boost circuit to enter a buck-boost mode when an absolute value of a voltage difference between the input voltage and the output voltage is less than a preset voltage threshold.

It may be understood that, when the absolute value of the voltage difference between the input voltage and the output voltage is less than the preset voltage threshold, that is, a ratio of the input voltage to the output voltage is close to 1, that is, when the output voltage is relatively close to the input voltage, because of a loss and a voltage drop on a switching transistor, it is difficult to match the output voltage even if a duty cycle of a switching transistor of a first bridge arm is topped up to 100%. Therefore, the buck-boost circuit needs to enter the buck-boost mode for operation, that is, the buck-boost circuit is controlled to enter the buck-boost mode.

Step S430: When the buck-boost circuit operates in the buck-boost mode, control conduction states of a first high-side switching transistor Q1, a first low-side switching transistor Q2, a second high-side switching transistor Q3, and a second low-side switching transistor Q4 in stages in each control cycle.

Control logic of each switching transistor is the same in each control cycle. Therefore, only a state in one control cycle is described.

Specifically, referring to FIG. 4B, in some embodiments, step S430 includes the following steps:

Sub-step S431: In a first stage, control both a first low-side switching transistor Q2 and a second low-side switching transistor Q4 to be conductive and control both a first high-side switching transistor Q1 and a second high-side switching transistor Q3 to be non-conductive, to simultaneously separately charge a first bootstrap circuit 1420 and a second bootstrap circuit.

Continue to refer to FIG. 5, which is a schematic diagram of drive signals of switching transistors when a buck-boost circuit operates in a buck-boost mode according to an embodiment of the present application. VQ1 is a drive signal wave used for driving the first high-side switching transistor Q1. VQ2 is a drive signal wave used for driving the first low-side switching transistor Q2. VQ3 is a drive signal wave used for driving the second high-side switching transistor Q3. VQ4 is a drive signal wave used for driving the second low-side switching transistor Q4. I1 is a current generated by the inductor 130 in a Continuous Conduction Mode (CCM). I2 is a current generated by the inductor 130 in a Discontinuous Conduction Mode (DCM). I1 and I2 in FIG. 1 do not appear simultaneously, but only for describing changes of currents of the inductor in different operating states. For example, when an inductor L operates in the CCM, a current change trend of the inductor L is shown as I1. When the inductor L operates in the DCM, a current change trend of the inductor L is shown as I2. It may be understood that when edges of the VQ1 and the VQ2 change simultaneously, and when edges of the VQ3 and the VQ4 change simultaneously, a dead time is further set to protect the same group of high-side and low-side transistors. Within the dead time, the same group of high-side and low-side transistors do not act. A Boost effective duty cycle is an energy storage time of the inductor when the buck-boost circuit operates in the buck-boost mode.

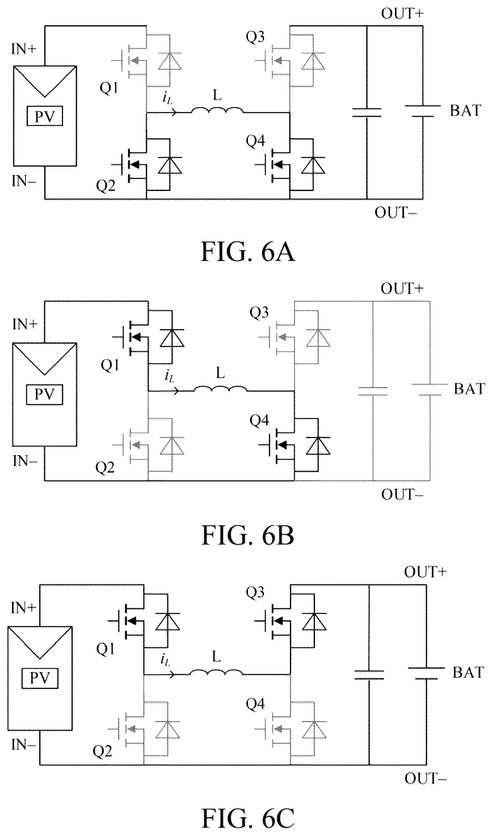

Referring to FIG. 5 and FIG. 6A together, it can be learned according to the operating principle of the bootstrap circuit introduced above that, in the first stage (t0-t1), by controlling the first low-side switching transistor Q2 and the second low-side switching transistor Q4 to be conductive and both the first high-side switching transistor Q1 and the second high-side switching transistor Q3 to be non-conductive, on one hand, bootstrap capacitors in the first bootstrap circuit 1420 and the second bootstrap circuit may be separately charged; and on the other hand, gains of the first bridge arm 110 and the second bridge arm 120 may be equivalently reduced, which is more in line with a current operating condition in which the ratio of the input voltage to the output voltage is close to 1.

It may be understood that, in the first stage, the first low-side switching transistor Q2 and the second low-side switching transistor Q4 are conductive, and both the first high-side switching transistor Q1 and the second high-side switching transistor Q3 are non-conductive, in this way, a voltage at two ends of the inductor 130 is 0, so that a current flowing through the inductor 130 in the first stage remains unchanged.

Sub-step S432: In a second stage, control both the first high-side switching transistor Q1 and the second low-side switching transistor Q4 to be conductive and control both the first low-side switching transistor Q2 and the second high-side switching transistor Q3 to be non-conductive.

Referring to FIG. 5 and FIG. 6B together, it may be understood that, in the second stage (t1-t2), the first low-side switching transistor Q2 to be non-conductive, so that a bootstrap capacitor in the first bootstrap circuit 1420 discharges electric energy, to drive the first high-side switching transistor Q1 to be conductive. Further, when both the first high-side switching transistor Q1 and the second low-side switching transistor Q4 are conductive, and both the first low-side switching transistor Q2 and the second high-side switching transistor Q3 are non-conductive, the direct current power supply device 20 (using PV as an example in the figure), the first high-side switching transistor Q1, the inductor 130, and the second low-side switching transistor Q4 form a loop together, and a current flows through the inductor 130, so that the current in the inductor 130 increases and the inductor 130 stores energy.

Sub-step S433: In a third stage, control both the first high-side switching transistor Q1 and the second high-side switching transistor Q3 to be conductive and control both the first low-side switching transistor Q2 and the second low-side switching transistor Q4 to be non-conductive.

Referring to FIG. 5 and FIG. 6C together, it may be understood that, in the third stage (t2-t3), the second low-side switching transistor Q4 is controlled to be non-conductive, so that a bootstrap capacitor in the second bootstrap circuit 150 discharges electric energy, to drive the second high-side switching transistor Q3 to be conductive. Further, when both the first high-side switching transistor Q1 and the second high-side switching transistor Q3 are conductive, and both the first low-side switching transistor Q2 and the second low-side switching transistor Q4 are non-conductive, the direct current power supply device 20, the first high-side switching transistor Q1, the inductor 130, the second high-side switching transistor Q3, and the load 30 form a loop together. In this case, if a voltage drop between the first high-side switching transistor Q1 and the second high-side switching transistor Q3 is ignored, voltages at the two ends of the inductor 130 are respectively voltages at the direct current input end and at the direct current output end. In this case, the inductor 130 operates in the CCM, and a current in the inductor 130 decreases.

According to the method for controlling a buck-boost circuit provided in the present application, an input voltage and an output voltage are first obtained, to control the buck-boost circuit to enter a buck-boost mode when the input voltage and the output voltage satisfy a preset condition. Then, when the buck-boost circuit operates in the buck-boost mode, a corresponding strategy of controlling four switching transistors in the buck-boost circuit is executed in each control cycle, so that a low-side switching transistor in the buck-boost circuit is conductive first, to charge the bootstrap capacitor. Then, when the low-side switching transistor is disconnected, bootstrap driving of the high-side switching transistor is implemented. In this way, according to the method for controlling a buck-boost circuit provided in the present application, bootstrap driving of the buck-boost circuit can be implemented, thereby reducing overall circuit costs.

In this way, by executing steps S410 to S430, when the buck-boost circuit enters the buck-boost mode, the bootstrap capacitor can be simultaneously charged to drive the first high-side switching transistor Q1 and the second high-side switching transistor Q3 while implementing control and waveform driving of the buck-boost circuit, thereby reducing overall circuit costs.

In some embodiments, when the buck-boost circuit operates in the buck-boost mode, the method for controlling a buck-boost circuit further includes: determining duration of the first stage according to a duty cycle of the first high-side switching transistor Q1.

Referring to FIG. 5, it may be understood that the duration of the control cycle is equal to a sum of duration of the first stage, the second stage, and the third stage. When the buck-boost circuit operates in the buck-boost mode, because both the first low-side switching transistor Q2 and the second low-side switching transistor Q4 are conductive in the first stage, and only the second low-side switching transistor Q4 is conductive in the second stage, the duration of the first stage may be determined according to a conductive time of the first low-side switching transistor Q2, that is, a duty cycle of the first low-side switching transistor Q2. Because a sum of the duty cycles of the first low-side switching transistor Q2 and the first high-side switching transistor Q1 is equal to 1, the duration of the first stage may further be determined according to the duty cycle of the first high-side switching transistor Q1.

For example, in some embodiments, a calculation formula for the duration of the first stage Δt₁ is:

$$Δ {t}_{1} = ( 1 - {D}_{1} ) * {T}_{s}$$

where TS represents a control cycle. D₁ represents the duty cycle of the first high-side switching transistor Q1. (1−D₁) represents the duty cycle of the first low-side switching transistor Q2. In this way, the duty cycle of the first low-side switching transistor Q2 may be adjusted to adjust charging duration of the bootstrap capacitor and energy obtained by charging. In some embodiments, when the buck-boost circuit operates in the buck-boost mode, the method for controlling the buck-boost circuit further includes: determining duration of the second stage according to the duty cycle of the first high-side switching transistor Q1 and a duty cycle of the second low-side switching transistor Q4.

Referring to FIG. 5, it may be understood that, according to a waveform diagram shown in FIG. 5, conduction duration of the first low-side switching transistor Q2 is subtracted from conduction duration of the second low-side switching transistor Q4 to obtain the duration of the second stage.

In this way, in some embodiments, a calculation formula for the duration Δt₂ of the second stage is:

$$Δ {t}_{2} = {t}_{2} - {t}_{1} = {D}_{2} * {T}_{s} - ( 1 - {D}_{1} ) * {T}_{s} = ( {D}_{1} + {D}_{2} - 1 ) * {T}_{s}$$

where D₂ represents a duty cycle of the second low-side switching transistor Q4. In this way, the duration of the second stage may be adjusted by adjusting the duty cycle of the first low-side switching transistor Q2 and the duty cycle of the second low-side switching transistor Q4.

Further, in the second stage, a calculation formula for the voltage at the two ends of the inductor 130 is:

$$L \frac{{di}_{L}}{dt} = {V}_{IN}$$

where L represents an induction quantity of the inductor 130.

$$\frac{{di}_{L}}{dt}$$

is a derivative of a current in the inductor with respect to time, and is used for indicating a changing speed of the current in the inductor. V_{IN} represents a direct current input voltage.

In this way, in the second stage, the voltage at the two ends of the inductor 130 is the direct current input voltage, so that a variation Δi_{L1} of the current in the inductor 130 in the second stage is

$$Δ {i}_{L 1} = \frac{{V}_{IN}}{L} Δ {t}_{2} = \frac{{V}_{IN}}{L} ( {D}_{1} + {D}_{2} - 1 ) * {T}_{s}$$

In some embodiments, when the buck-boost circuit operates in the buck-boost mode, the method for controlling a buck-boost circuit further includes: determining the duration of a third stage according to a duty cycle of the second high-side switching transistor Q3.

Referring to FIG. 5, it may be understood that conduction duration of the second high-side switching transistor Q3 is approximately the same as the duration of the third stage. In addition, because a sum of the duty cycle of the second high-side switching transistor Q3 and the duty cycle of the second low-side switching transistor Q4 is 1, in this way, the duty cycle of the second high-side switching transistor Q3 may be obtained as (1−D₂).

In this way, in some embodiments, a calculation formula for the duration of the third stage Δt₃ is:

$$Δ {t}_{3} = {t}_{3} - {t}_{2} = ( 1 - {D}_{2} ) * {T}_{s}$$

It may be understood that, in the third stage, the voltage at the two ends of the inductor 130 is a voltage difference between the direct current input voltage and the direct current output voltage. In this way, in the third stage, the voltage at the two ends of the inductor 130 is:

$$L \frac{{di}_{L}}{dt} = {V}_{IN} - {V}_{OUT}$$

where V_{OUT} represents the direct current output voltage.

Further, a calculation formula for the variation of the current in the inductor 130 in the third stage Δi_{L2} is:

$$Δ {i}_{L 2} = \frac{{V}_{IN} - {V}_{OUT}}{L} Δ {t}_{2} = \frac{{V}_{IN} - {V}_{OUT}}{L} ( 1 - {D}_{2} ) * {T}_{s}$$

Because the variation of the current in the inductor in one switching cycle is 0, that is, Δi_{L1}+Δi_{L2}=0, in this way, a calculation formula of the direct current output voltage may be obtained as:

$${V}_{OUT} = \frac{{D}_{1}}{1 - {D}_{2}} {V}_{IN}$$

In this way, the duty cycle D₁ of the first high-side switching transistor Q1 and the duty cycle D₂ of the second low-side switching transistor Q4 may be adjusted by using a control loop (not shown in the figure), to enable the voltages at the direct current input end and the direct current output end to be the same, so that the buck-boost circuit operates in the buck-boost mode.

It may be understood that the foregoing provided methods for calculating the duration of the first stage, the duration of the second stage, and the duration of the third stage are some embodiments provided in the present application. The present application does not limit the method for calculating the duration of the stages. In another embodiment, a person skilled in the art may calculate the duration of the first stage, the duration of the second stage, and the duration of the third stage according to the obtained parameters such as the duty cycle of the another switching transistor and the waveform diagram shown in FIG. 5.

It may be understood that, the buck-boost circuit may further be switched to another operating mode according to the direct current input voltage and the direct current output voltage. The following describes how to drive the switching transistor in the buck-boost circuit by using the bootstrap circuit when the buck-boost circuit operates in another mode.

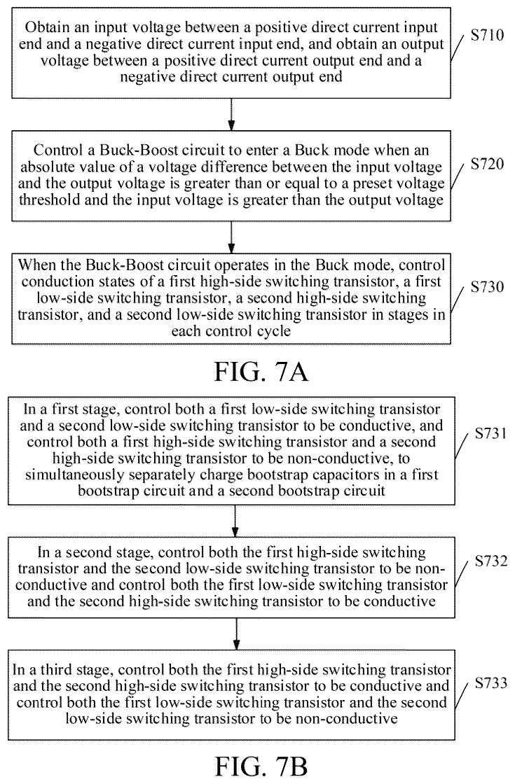

Referring to FIG. 7A, in some embodiments, the method for controlling a buck-boost circuit further includes the following steps:

Step S710: Obtain an input voltage at a direct current input end and an output voltage at a direct current output end.

It may be understood that, step S710 is roughly the same as or similar to step S410, and details are not described herein again.

Step S720: Control a buck-boost circuit to enter a Buck mode when an absolute value of a voltage difference between the input voltage and the output voltage is greater than or equal to a preset voltage threshold and the input voltage is greater than the output voltage.

It may be understood that, when the absolute value of the voltage difference between the input voltage and the output voltage is greater than or equal to the preset voltage threshold, it indicates that the voltage difference between the input voltage and the output voltage is relatively large. Moreover, when the input voltage is greater than the output voltage, to satisfy a voltage requirement of the load 30, the buck-boost circuit is controlled to enter the Buck mode, to step down the input voltage.

Step S730: When the buck-boost circuit operates in the Buck mode, control conduction states of a first high-side switching transistor Q1, a first low-side switching transistor Q2, a second high-side switching transistor Q3, and a second low-side switching transistor Q4 in stages in each control cycle.

Referring to FIG. 7B, specifically, step S730 includes the following steps:

Sub-step S731: In a first stage, control both a first low-side switching transistor Q2 and a second low-side switching transistor Q4 to be conductive, and control both a first high-side switching transistor Q1 and a second high-side switching transistor Q3 to be non-conductive, to simultaneously separately charge bootstrap capacitors in a first bootstrap circuit 1420 and a second bootstrap circuit 1520.

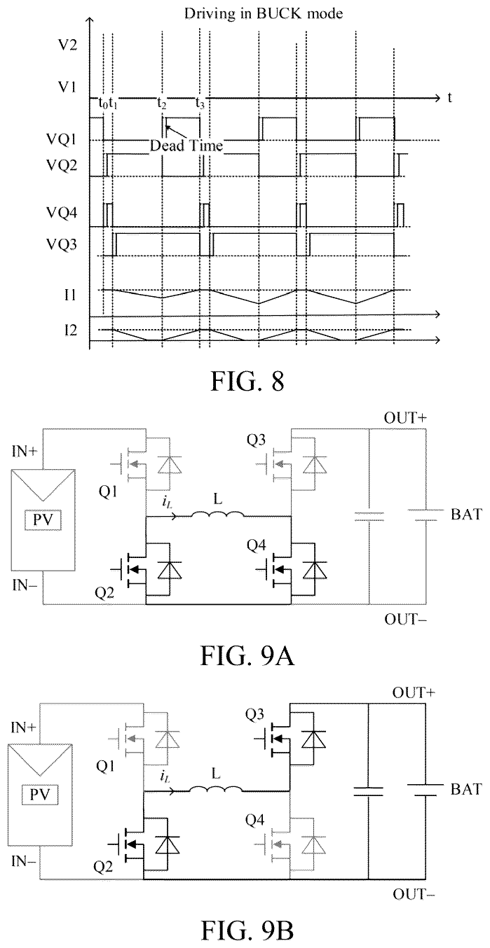

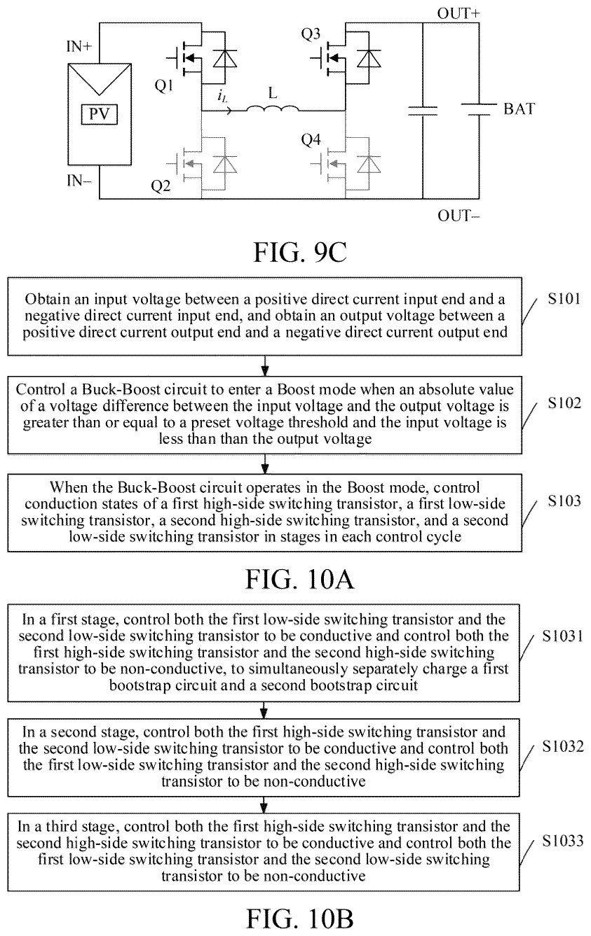

Referring to FIG. 8 and FIG. 9A together, FIG. 8 is a schematic diagram of drive signals of switching transistors when a buck-boost circuit operates in a Buck mode. Meanings of the signal waves in FIG. 8 are roughly the same as those of the signal waves in FIG. 5, and details are not described herein again. For details, refer to related introductions in FIG. 5 again. It can be known according to the operating principle of the bootstrap circuit introduced above that, in the first stage (t0-t1), the first low-side switching transistor Q2 and the second low-side switching transistor Q4 are controlled to be conductive, so that bootstrap capacitors in the first bootstrap circuit 1420 and the second bootstrap circuit can be separately charged.

Similarly, in the first stage, a voltage at two ends of the inductor 130 is 0, so that a current flowing through the inductor 130 remains unchanged in the first stage.

In the BUCK mode, duration of the first stage may be set according to requirements, and only relatively short duration is required for ensuring that there is sufficient energy on a bootstrap capacitor that drives the second high-side switching transistor Q3. That is, in this case, a waveform of VQ4 is a pulse wave having a relatively small duty cycle, so that conduction duration of the second low-side switching transistor Q4 is controlled. The duration may be set according to experience, or may be set according to energy required for driving the second high-side switching transistor Q3.

It can be known according to the diagram shown in FIG. 8 that, in some embodiments, duration of the first stage may be calculated according to a duty cycle of the second low-side switching transistor Q4. A calculation formula for the duration Δt₁ of the first stage is:

$$Δ {t}_{1} = {D}_{2} * {T}_{s}$$

where D₂ represents the duty cycle of the second low-side switching transistor Q4 when the buck-boost circuit enters the Buck mode, and TS represents a control cycle.

Sub-step S732: In a second stage, control both the first high-side switching transistor Q1 and the second low-side switching transistor Q4 to be non-conductive and control both the first low-side switching transistor Q2 and the second high-side switching transistor Q3 to be conductive.

Referring to FIG. 8 and FIG. 9B together, in the second stage (t1-t2), the second low-side switching transistor Q4 is controlled to be non-conductive, so that a bootstrap capacitor in the second bootstrap circuit discharges electric energy, to drive the second high-side switching transistor Q3 to be conductive. In this way, in the second stage, when both the first high-side switching transistor Q1 and the second low-side switching transistor Q4 are non-conductive, and both the first low-side switching transistor Q2 and the second high-side switching transistor Q3 are conductive, the load 30, the second high-side switching transistor Q3, the inductor 130, and the second low-side switching transistor Q2 form a loop together, and a voltage at the two ends of the inductor 130 is −VBAT. In this way, the inductor 130 operates in the CCM, and a current in the inductor 130 decreases.

Referring to FIG. 8, in some embodiments, a calculation formula for the duration of the second stage Δt₂ is:

$$Δ {t}_{2} = {t}_{2} - {t}_{1} = ( 1 - {D}_{1} ) * {T}_{s} - {D}_{2} * {T}_{s} - = ( 1 - {D}_{1} - {D}_{2} ) * {T}_{s}$$

where D₁ represents the duty cycle of the first high-side switching transistor Q1. (1−D₁) represents the duty cycle of the first low-side switching transistor Q2. D₂ represents the duty cycle of the second low-side switching transistor Q4. In this way, the duration of the second stage may be adjusted by adjusting the duty cycle of the first high-side switching transistor Q1 and the duty cycle of the second low-side switching transistor Q4.

It may be understood that, in the second stage, a calculation formula for the voltage at the two ends of the inductor 130 is:

$$L \frac{{di}_{L}}{dt} = - {V}_{OUT}$$

Sub-step S733: In a third stage, control both the first high-side switching transistor Q1 and the second high-side switching transistor Q3 to be conductive and control both the first low-side switching transistor Q2 and the second low-side switching transistor Q4 to be non-conductive.

Referring to FIG. 8 and FIG. 9C together, it may be understood that, in the third stage (t2-t3), the first low-side switching transistor Q2 is continuously controlled to be non-conductive, so that a bootstrap capacitor in the first bootstrap circuit 1420 discharges electric energy, to drive the first high-side switching transistor Q1 to be conductive. Further, when both the first high-side switching transistor Q1 and the second high-side switching transistor Q3 are conductive and both the first low-side switching transistor Q2 and the second low-side switching transistor Q4 are non-conductive, the direct current power supply device 20, the first high-side switching transistor Q1, the inductor 130, the second high-side switching transistor Q3, and the load 30 form a loop. In this case, high-side transistors of two bridge arms are conductive, this duration is a time of an effective duty cycle of a BUCK circuit. In this way, the voltage at the two ends of the inductor 130 is positive, and the current in the inductor 130 increases.

Referring to FIG. 8, in some embodiments, a calculation formula for the duration of the third stage Δt₃ is:

$$Δ {t}_{3} = {t}_{3} - {t}_{2} = {D}_{1} * {T}_{s}$$

where D₁ represents the duty cycle of the first high-side switching transistor Q1. In this way, the duration of the third stage can be adjusted by adjusting the duty cycle of the first high-side switching transistor Q1.

In a third stage, a calculation formula for an output voltage V_{OUT} is:

$${V}_{OUT} = {V}_{IN} * {D}_{1} .$$

In the present application, by executing steps S710 to S730, when the buck-boost circuit enters the Buck mode, the bootstrap capacitor can be charged while implementing control and waveform driving of the buck-boost circuit, thereby reducing overall circuit costs.

In some embodiments, duration of the first stage in which the buck-boost circuit operates in the Buck mode is less than duration of the first stage in which the buck-boost circuit operates in the buck-boost mode. It may be understood that in the BUCK-BOOST mode, a composition of BUCK needs to be formed by conducting a low-side transistor (for example, the first low-side switching transistor Q2 or the second low-side switching transistor Q4). However, in the BUCK mode and a BOOST mode, as long as driving of a high-side transistor (for example, the first high-side switching transistor Q1 or the second high-side switching transistor Q3) can be satisfied, relatively short duration of the first stage may be set.

It may be understood that duration of the first stage is related to the bootstrap capacitor. For example, in some embodiments, duration of the first stage in which the buck-boost circuit operates in the Buck mode meets a requirement on duration for charging the bootstrap capacitor.

Referring to FIG. 10A, in some embodiments, the method for controlling a buck-boost circuit further includes the following steps:

Step S101: Obtain an input voltage at a direct current input end and an output voltage at a direct current output end.

It may be understood that, step S101 is roughly the same as or similar to step S410, and details are not described herein again.

Step S102: Control a buck-boost circuit to enter a Boost mode when an absolute value of a voltage difference between the input voltage and the output voltage is greater than or equal to a preset voltage threshold and the input voltage is less than the output voltage.

It may be understood that, when the absolute value of the voltage difference between the input voltage and the output voltage is greater than or equal to the preset voltage threshold, it indicates that the voltage difference between the input voltage and the output voltage is relatively large. Moreover, when the input voltage is less than the output voltage, to stabilize the output voltage, the buck-boost circuit is controlled to enter the Boost mode, to boost the input voltage, so as to output a voltage suitable for the load.

Step S103: When the buck-boost circuit operates in the Boost mode, control conduction states of a first high-side switching transistor, a first low-side switching transistor, a second high-side switching transistor, and a second low-side switching transistor in stages in each control cycle.

Referring to FIG. 10B, specifically, step S103 may include:

Sub-step S1031: In a first stage, control both the first low-side switching transistor and the second low-side switching transistor to be conductive and control both the first high-side switching transistor and the second high-side switching transistor to be non-conductive, to simultaneously separately charge a first bootstrap circuit and a second bootstrap circuit.

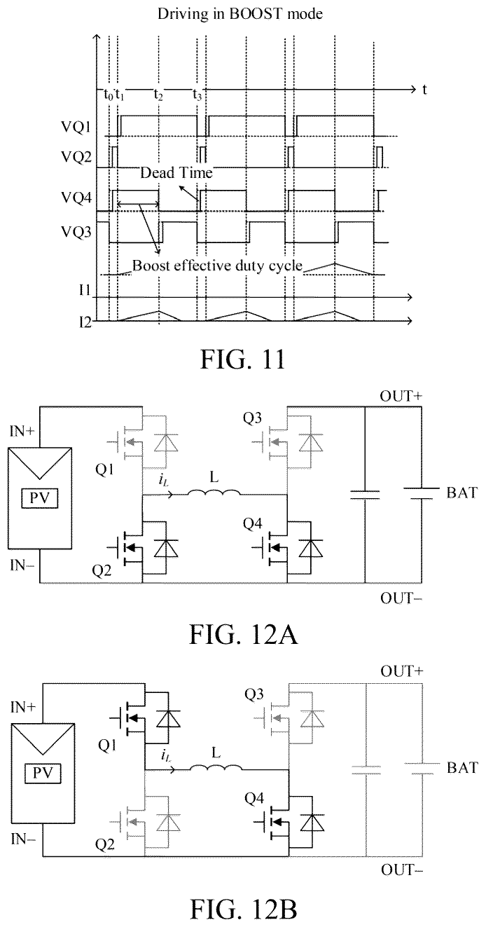

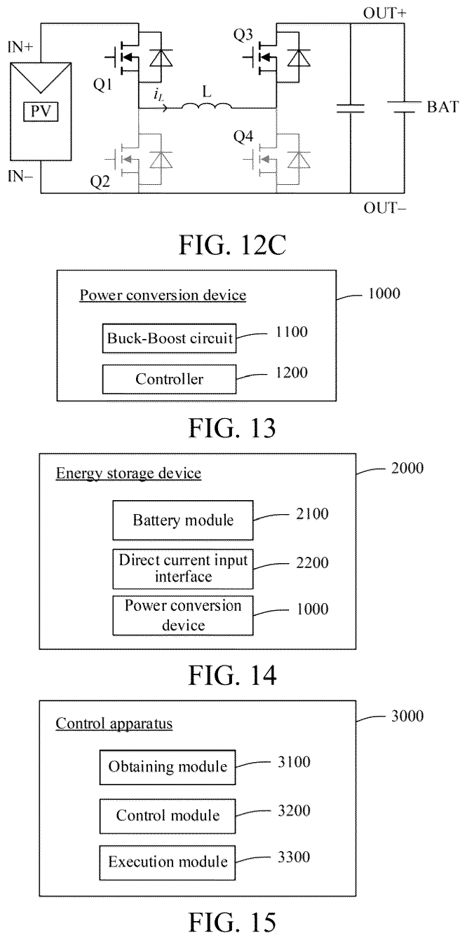

Referring to FIG. 11 and FIG. 12A together, FIG. 11 is a schematic diagram of drive signals of switching transistors when the buck-boost circuit operates in a Boost mode. Meanings of the signal waves in FIG. 11 are roughly the same as those of the signal waves in FIG. 5, and details are not described herein again. For details, refer to related introductions in FIG. 5 again. Similarly, in the first stage (t0-t1), the first low-side switching transistor Q2 and the second low-side switching transistor Q4 are controlled to be conductive, so that bootstrap capacitors in the first bootstrap circuit 1420 and the second bootstrap circuit can be separately charged. In this case, a voltage at two ends of the inductor 130 is 0, so that a current flowing through the inductor 130 remains unchanged in the first stage.

In the BOOST mode, duration of the first stage may be set according to requirements, and only relatively short duration is required for ensuring that there is sufficient energy on a bootstrap capacitor that drives the first high-side switching transistor Q1. That is, in this case, a waveform of VQ2 is a pulse wave having a relatively small duty cycle, so that conduction duration of the first low-side switching transistor Q2 is controlled. The duration may be set according to experience, or may be set according to energy required for driving the first high-side switching transistor Q1.

It may be understood that, a calculation formula for the duration Δt₁ of the first stage is:

$$Δ {t}_{1} = ( 1 - {D}_{1} ) * {T}_{s}$$

where D₁ represents the duty cycle of the first high-side switching transistor Q1 when the buck-boost circuit enters the Boost mode, (1−D₁) represents a duty cycle of the first low-side switching transistor Q2, and (1−D₁) represents a control cycle.

Sub-step S1032: In a second stage, control both the first high-side switching transistor and the second low-side switching transistor to be conductive and control both the first low-side switching transistor and the second high-side switching transistor to be non-conductive.

Referring to FIG. 11 and FIG. 12B together, in the second stage (t1-t2), the first low-side switching transistor Q2 is controlled to be non-conductive, so that a bootstrap capacitor in the first bootstrap circuit 1420 discharges electric energy, to drive the first high-side switching transistor Q1 to be conductive. In this way, in the second stage, when both the first high-side switching transistor Q1 and the second low-side switching transistor Q4 are conductive, and both the first low-side switching transistor Q2 and the second high-side switching transistor Q3 are non-conductive, the direct current power supply device 20, the first high-side switching transistor Q1, the inductor 130, and the second low-side switching transistor Q4 form a loop together. In this case, the voltage at two ends of the inductor 130 is a voltage output by the direct current power supply device 20, and a current flows through the inductor 130, so that the current in the inductor 130 increases, and the inductor 130 enters an energy storage state.

A calculation formula for the duration Δt₂ of the second stage is:

$$Δ {t}_{2} = {t}_{2} - {t}_{1} = {D}_{2} * {T}_{s} - ( 1 - {D}_{1} ) * {T}_{s} = ( {D}_{1} + {D}_{2} - 1 ) * {T}_{s}$$

where D₂ represents a duty cycle of the second low-side switching transistor Q4. In this way, the duration of the second stage may be adjusted by adjusting the duty cycle of the first low-side switching transistor Q2 and the duty cycle of the second low-side switching transistor Q4.

In the second stage, a calculation formula for the voltage at the two ends of the inductor 130 is:

$$L \frac{{di}_{L}}{dt} = {V}_{IN}$$

In this way, in the second stage, a variation Δi_{L1} of a current in the inductor 130 is:

$$Δ {i}_{L 1} = \frac{{V}_{IN}}{L} Δ {t}_{2} = \frac{{V}_{IN}}{L} ( {D}_{1} + {D}_{2} - 1 ) * {T}_{s}$$

Sub-step S1033: In a third stage, control both the first high-side switching transistor and the second high-side switching transistor to be conductive and control both the first low-side switching transistor and the second low-side switching transistor to be non-conductive.

Referring to FIG. 11 and FIG. 12C together, in the third stage (t2-t3), the second low-side switching transistor Q4 is continued to be controlled to be non-conductive, so that a bootstrap capacitor in the second bootstrap circuit discharges electric energy, to drive the second high-side switching transistor Q3 to be conductive. In this way, in the third stage, when both the first high-side switching transistor Q1 and the second high-side switching transistor Q3 are conductive and both the first low-side switching transistor Q2 and the second low-side switching transistor Q4 are non-conductive, the direct current power supply device 20, the first high-side switching transistor Q1, the inductor 130, the second high-side switching transistor Q3, and the load 30 form a loop together. In the Boost mode, the input voltage is less than the output voltage. In this way, the two ends of the inductor 130 withstand reverse voltages. In addition, in the third stage, the inductor 130 operates in the CCM, and the current in the inductor 130 decreases.

A calculation formula for the duration Δt₃ of the third stage is:

$$Δ {t}_{3} = {t}_{3} - {t}_{2} = ( 1 - {D}_{2} ) * {T}_{s}$$

In this way, in the third stage, a calculation formula for the voltage at the two ends of the inductor 130 is:

$$L \frac{{di}_{L}}{dt} = {V}_{IN} - {V}_{OUT}$$

Further, a calculation formula for the variation Δi_{L2} of the current in the inductor 130 in the third stage is:

$$Δ {i}_{L 2} = \frac{{V}_{IN} - {V}_{OUT}}{L} Δ {t}_{2} = \frac{{V}_{IN} - {V}_{OUT}}{L} ( 1 - {D}_{2} ) * {T}_{s}$$

Because the variation of the current in the inductor in one switching cycle is 0, that is, Δi_{L1}+Δi_{L2}=0, in this way, a calculation formula of the direct current output voltage may be obtained as:

$${V}_{OUT} = \frac{{D}_{1}}{1 - {D}_{2}} {V}_{IN}$$

In this way, by executing steps S101 to S103, when the buck-boost circuit enters the Boost mode, the bootstrap capacitor can be charged while implementing control and waveform driving of the buck-boost circuit, thereby reducing overall circuit costs.

In some embodiments, the method for controlling the buck-boost circuit further includes:
duration of the first stage in which the buck-boost circuit operates in the Boost mode is less than duration of the first stage in which the buck-boost circuit operates in the buck-boost mode.

It may be understood that an absolute value of a voltage difference between an input voltage and an output voltage when the buck-boost circuit operates in the Boost mode is greater than or equal to a preset voltage threshold. When the buck-boost circuit operates in the buck-boost mode, the absolute value of the voltage difference between the input voltage and the output voltage is less than the preset voltage threshold. In this way, according to the foregoing description, it may alternatively be obtained that the duration of the first stage in which the buck-boost circuit operates in the Boost mode is less than the duration of the first stage in which the buck-boost circuit operates in the buck-boost mode.

It may be understood that duration of the first stage is related to the bootstrap capacitor. For example, in some embodiments, duration of the first stage in which the buck-boost circuit operates in the Boost mode meets a requirement on duration for charging the bootstrap capacitor.

Referring to FIG. 13, an embodiment of the present application further provides a power conversion device 1000, including a buck-boost circuit 1100 and a controller 1200. The controller 1200 is configured to execute the method for controlling a buck-boost circuit according to any one of the foregoing items.

It may be understood that the power conversion device 1000 may be integrated into an electronic device, or may be independently disposed. The power conversion device 1000 may charge a battery module on the electronic device by using a power supply signal output by an external device, or supply power to a connected external device by using a battery module on the electronic device.

Referring to FIG. 14, the present application further provides an energy storage device 2000, including a battery module 2100, a direct current input interface 2200, and a power conversion device 1000. The battery module 2100 is electrically connected to a direct current output end of the buck-boost circuit 1100 in the power conversion device 1000. The direct current input interface 2200 is configured to be connected to a direct current power supply (not shown in the figure), and the direct current input interface is connected to a direct current input end of the buck-boost circuit 1100. In this way, the energy storage device 2000 may receive a direct current voltage of the direct current power supply by using a direct current input interface, and convert the direct current voltage into another direct current voltage by using the buck-boost circuit 1100 to output the another direct current voltage to the battery module 2100, so as to charge the battery module 2100. In this way, the energy storage device 2000 using the power conversion device 1000 is driven by charging and discharging of a bootstrap capacitor, which can effectively reduce overall circuit costs.

An implementation of the present application further provides a control apparatus, applied to a buck-boost circuit. FIG. 15 schematically shows a structural block diagram of a control apparatus 3000 provided in this embodiment of the present application. As shown in FIG. 15, the control apparatus 3000 includes an obtaining module 3100, a control module 3200, an execution module 3300.

The obtaining module 3100 is configured to obtain an input voltage at a direct current input end and an output voltage at a direct current output end of a buck-boost circuit.

The control module 3200 is configured to control the buck-boost circuit to enter a buck-boost mode when an absolute value of a voltage difference between the input voltage and the output voltage is less than a preset voltage threshold.

The execution module 3300 is configured to: when the buck-boost circuit operates in the buck-boost mode execute, execute within each control cycle:
in a first stage, controlling both a first low-side switching transistor and a second low-side switching transistor to be conductive and controlling both a first high-side switching transistor and a second high-side switching transistor to be non-conductive, to simultaneously separately charge a first bootstrap circuit and a second bootstrap circuit; in a second stage, controlling both the first high-side switching transistor and the second low-side switching transistor to be conductive and controlling both the first low-side switching transistor and the second high-side switching transistor to be non-conductive; and in a third stage, controlling both the first high-side switching transistor and the second high-side switching transistor to be conductive and controlling both the first low-side switching transistor and the second low-side switching transistor to be non-conductive.

It may be understood that the control module 3200 is further configured to control the buck-boost circuit to enter a Buck mode when the absolute value of the voltage difference between the input voltage and the output voltage is greater than or equal to the preset voltage threshold and the input voltage is greater than the output voltage. The control module 3200 is further configured to control the buck-boost circuit to enter a Boost mode when the absolute value of the voltage difference between the input voltage and the output voltage is less than the preset voltage threshold and the input voltage is less than the output voltage.

The execution module 3300 is further configured to execute corresponding control on the first high-side switching transistor, the first low-side switching transistor, the second high-side switching transistor, and the second low-side switching transistor when the control module 3200 controls the buck-boost circuit to enter the Buck mode or the Boost mode. For a specific control process, refer to the foregoing corresponding embodiments, and details are not described herein again.

Specific details that the control apparatus provided in this embodiment of the present application implements the method for controlling a buck-boost circuit have been described in detail in the corresponding embodiment of the method for controlling a buck-boost circuit, and details are not described herein again.

The present application further provides a computer-readable medium, having a computer program stored thereon. The computer program implements, when executed by a processor, the method for controlling a buck-boost circuit in the foregoing technical solution. The computer-readable medium may use a portable Compact Disc Read-Only Memory (CD-ROM) and include program code, and may run on a terminal device, for example, a personal computer. However, a program product of the present application is not limited thereto. In this file, a readable storage medium may be any tangible medium that includes or stores a program, and the program may be used by or in combination with an instruction execution system, apparatus, or device.

The foregoing program product may use any combination of one or more readable media. The readable medium may be a readable signal medium or a readable storage medium. For example, the readable storage medium may be, but is not limited to, an electronic, magnetic, optical, electromagnetic, infrared, or semiconductor system, apparatus, or device, or a combination of any of the foregoing. More specific examples (a non-exhaustive list) of the readable storage medium include: an electrical connection having one or more wires, a portable disc, a hard disc, a Random Access Memory (RAM), a Read-Only Memory (ROM), an Erasable Programmable Read-Only Memory (EPROM or flash memory), an optical fiber, a portable CD-ROM, an optical storage device, a magnetic storage device, or any suitable combination of the foregoing.

In addition, the foregoing accompanying drawings are merely exemplary descriptions of processes included in a method according to an exemplary embodiment of the present application, and are not intended to limit the present application. It is easy to understand that the processes shown in the foregoing accompanying drawings does not indicate or limit a time sequence of the processing. In addition, it is also easy to understand that the processes may be, for example, synchronously or asynchronously executed in a plurality of modules.

The foregoing descriptions are merely specific implementations of the present application, but are not intended to limit the protection scope of the present application. Any person skilled in the art can easily obtain various equivalent modifications or replacements within the technical scope disclosed in the present application, and these modifications or replacements fall within the protection scope of the present application. Therefore, the protection scope of the present application is subject to the protection scope of the claims.

What is claimed is:

1. A method for controlling a buck-boost circuit, the buck-boost circuit comprising a first bridge arm, a second bridge arm, an inductor, a first bootstrap circuit, and a second bootstrap circuit, wherein the first bridge arm comprises a first high-side switching transistor and a first low-side switching transistor that are connected between a positive direct current input end and a negative direct current input end; the second bridge arm comprises a second high-side switching transistor and a second low-side switching transistor that are connected between a positive direct current output end and a negative direct current output end; the inductor is connected between a midpoint of the first bridge arm and a midpoint of the second bridge arm; the first bootstrap circuit is configured to perform bootstrap driving on the first high-side switching transistor; the second bootstrap circuit is configured to perform bootstrap driving on the second high-side switching transistor; and the control method comprises:
obtaining an input voltage between the positive direct current input end and the negative direct current input end, and obtaining an output voltage between the positive direct current output end and the negative direct current output end;
controlling the buck-boost circuit to enter a buck-boost mode when an absolute value of a voltage difference between the input voltage and the output voltage is less than a preset voltage threshold; and
when the buck-boost circuit operates in the buck-boost mode, executing within each control cycle:
in a first stage, controlling both the first low-side switching transistor and the second low-side switching transistor to be conductive and controlling both the first high-side switching transistor and the second high-side switching transistor to be non-conductive, to simultaneously separately charge the first bootstrap circuit and the second bootstrap circuit;
in a second stage, controlling both the first high-side switching transistor and the second low-side switching transistor to be conductive and controlling both the first low-side switching transistor and the second high-side switching transistor to be non-conductive; and
in a third stage, controlling both the first high-side switching transistor and the second high-side switching transistor to be conductive and controlling both the first low-side switching transistor and the second low-side switching transistor to be non-conductive.

2. The method according to claim 1, further comprising:
determining duration of the first stage according to a duty cycle of the first high-side switching transistor.

3. The method according to claim 1, further comprising:
determining duration of the second stage according to a duty cycle of the first high-side switching transistor and a duty cycle of the second low-side switching transistor.

4. The method according to claim 1, further comprising:
determining duration of the third stage according to a duty cycle of the second high-side switching transistor.

5. The method according to claim 1, further comprising:
controlling the buck-boost circuit to enter a Buck mode when the absolute value of the voltage difference between the input voltage and the output voltage is greater than or equal to the preset voltage threshold and when the input voltage is greater than the output voltage; and
when the buck-boost circuit operates in the Buck mode, executing within each control cycle:
in a first stage, controlling both the first low-side switching transistor and the second low-side switching transistor to be conductive and controlling both the first high-side switching transistor and the second high-side switching transistor to be non-conductive, to simultaneously separately charge the first bootstrap circuit and the second bootstrap circuit;
in a second stage, controlling both the first high-side switching transistor and the second low-side switching transistor to be non-conductive and controlling both the first low-side switching transistor and the second high-side switching transistor be conductive; and
in a third stage, controlling both the first high-side switching transistor and the second high-side switching transistor to be conductive and controlling both the first low-side switching transistor and the second low-side switching transistor to be non-conductive.

6. The method according to claim 5, wherein
duration of the first stage in which the buck-boost circuit operates in the Buck mode is less than duration of the first stage in which the buck-boost circuit operates in the buck-boost mode.

7. The method according to claim 1, further comprising:
controlling the buck-boost circuit to enter a Boost mode when the absolute value of the voltage difference between the input voltage and the output voltage is greater than or equal to the preset voltage threshold and when the input voltage is less than the output voltage; and
when the buck-boost circuit operates in the Boost mode, executing within each control cycle:
in a first stage, controlling both the first low-side switching transistor and the second low-side switching transistor to be conductive and controlling both the first high-side switching transistor and the second high-side switching transistor to be non-conductive, to simultaneously separately charge the first bootstrap circuit and the second bootstrap circuit;
in a second stage, controlling both the first high-side switching transistor and the second low-side switching transistor to be conductive and controlling both the first low-side switching transistor and the second high-side switching transistor to be non-conductive; and
in a third stage, controlling both the first high-side switching transistor and the second high-side switching transistor to be conductive and controlling both the first low-side switching transistor and the second low-side switching transistor to be non-conductive.

8. A power conversion device, comprising a buck-boost circuit and a controller, wherein the controller is configured to execute the method according to claim 1.

9. An energy storage device, comprising a battery module, a direct current input interface, and the power conversion device according to claim 8, wherein the battery module is connected to a direct current output end of the buck-boost circuit; and the direct current input interface is configured to be connected to a direct current power supply, and the direct current input interface is connected to a direct current input end of the buck-boost circuit.

10. A computer-readable storage medium, the computer-readable storage medium storing a computer program, wherein the computer program, when executed by a processor, enables the processor to implement the method for controlling a buck-boost circuit according to claim 1.
